(19) United States
(12) Patent Application Publication
(10) Pub. No.: US 2015/0254594 A1
(43) Pub. Date: Sep. 10, 2015

(54) System for Interactively Visualizing and Evaluating User Behavior and Output

(71) Applicant: CARNEGIE MELLON UNIVERSITY, Pittsburgh, PA (US)

(72) Inventors: Aniket Dilip Kittur, Pittsburgh, PA (US); Jeffrey Mark Rzeszotarski, Chesterland, OH (US)

(73) Assignee: Carnegie Mellon University, Pittsburgh, PA (US)

(21) Appl. No.: 14/431,816

(22) PCT Filed: Sep. 27, 2013
(86) PCT No.: PCT/US13/62148

§ 371 Date: Mar. 27, 2015

Related U.S. Application Data
(60) Provisional application No. 61/744,490, filed on Sep. 27, 2012.

(51) Int. Cl. G06Q 10/06; G06N 5/04; G06Q 50/00; G06N 99/00

(52) U.S. Cl. CPC G06Q 10/06398; G06N 99/005; G06N 5/04; G06Q 50/01

(57) ABSTRACT

The present invention discloses CrowdScape, a system that supports the human evaluation of complex crowd work through interactive visualization and mixed initiative machine learning. The system combines information about worker behavior with worker outputs and aggregate worker behavioral traces to allow the isolation of target worker clusters. This approach allows users to develop and test their mental models of tasks and worker behaviors, and then ground those models in worker outputs and majority or gold standard verifications.

### RELATED APPLICATIONS

This application claims the benefit of U.S. Provisional application 61/744,490, filed Sep. 27, 2012.

### GOVERNMENT RIGHTS

This invention was made with government support under the NSF Number IIS-0968484. The government has certain rights in this invention.

### BACKGROUND

Crowdsourcing markets help organizers distribute work in a massively parallel fashion, enabling researchers to generate large datasets of translated text, quickly label geographic data, or even design new products. However, distributed work comes with significant challenges for quality control. Approaches include algorithmically using tools such as gold standard questions that verify if a worker is accurate on a prescribed baseline, majority voting where more common answers are weighted, or behavioral traces where certain behavioral patterns are linked with outcome measures. Crowd organization algorithms such as Partition-Map-Reduce, Find-Fix-Verify, and Price-Divide-Solve distribute the burden of breaking up, integrating, and checking work to the crowd.

These algorithmic approaches can be effective in deterministic or constrained tasks such as image transcription or tagging, but they become less effective as tasks are made more complex or creative. For example, subjective tasks may have no single “right” answer, and in generative tasks such as writing or drawing no two answers may be identical. Conversely, looking at the way workers behave when engaged in a task (e.g., how they scroll, change focus, move their mouse) rather than their output can overcome some of these challenges, but may not be sufficiently accurate on its own to determine which work to accept or reject. Furthermore, two workers may complete a task in very different ways yet both provide valid output.

Low quality work is common in crowdsourcing markets, comprising up to an estimated one third of all submissions. As a result, researchers have investigated several ways of detecting and correcting for low quality work by either studying the post-hoc pool of outputs or the ongoing behavior of a worker.

Validated ‘gold standard’ questions can be seeded into a task with the presumption that workers who answer the gold standard questions incorrectly can be filtered out or given corrective feedback. In the case of well-defined tasks such as transcribing a business card, it is easy to insert validated questions. However, in more complex tasks such as writing, validation questions often do not apply. Other researchers have suggested using trends or majority voting to identify good answers, or to have workers rate other workers' submissions. While these techniques can be effective (especially so when the range of outputs is constrained) they also are subject to gaming or majority effects and may completely break down in situations where there are no answers in common such as in creative or generative work. Another method researchers have employed relies on organizing and visualizing crowd workflows in order to guarantee or work towards better results. Turkomatic and CrowdWeaver use directed graph visualizations to show the organization of crowd tasks, allowing users to better understand their workflow and design for higher quality. CrowdForge and Jabberwocky use programmatic paradigms to similarly allow for more optimal task designs. These tools can provide powerful ways of organizing and managing complex workflows, but are not suited to all tasks and require iteration to perfect.

Another line of research suggests that looking at the manner in which workers complete a task might provide enough information to make inferences about their final products. For example, a worker who quickly enters tags one after the other may be doing a poorer job than a worker who enters a tag, pauses to glance back at the image, and then enters another. While examining these implicit behavioral features can be effective, it requires that at least some of the feature vectors be labeled by examining and evaluating worker outputs manually. CrowdFlower's analytics tools address this issue, aligning post-hoc outcomes such as gold standard question responses with individual workers in visual form. As a result, this tool can expose general worker patterns, such as failing certain gold questions or spending too little time on a task. However, without access to detailed behavioral trace data, the level of feedback it can provide to task organizers is limited.

While each of these categories has advantages and disadvantages, in the case of creative or complex work, none are sufficient alone. There may not be enough data to train predictive models for behavioral traces, or it may be difficult to seed gold standard questions. Yet, in concert, both post-hoc output analysis and behavioral traces provide valuable complementary insights. For example, imagine the case of image tagging. We may not have enough labeled points to build a predictive model for a worker who enters tags in rapid succession, but we may recognize that this worker submits two short tags. Another worker may also enter the same two tags and share a similar behavioral trace.

From this we might posit that those two tags are indicators of workers who behave in a slipshod manner. By combining both behavioral observations and knowledge of worker output, we gain new insight into how the crowd performs.

### SUMMARY OF THE INVENTION

Disclosed herein as the present invention is CrowdScape, a novel system that supports the evaluation of complex and creative crowdwork by combining information about worker behavior with worker outputs through mixed initiative machine learning (ML), visualization, and interaction. By connecting multiple forms of data, CrowdScape allows users to develop insights about their crowd's performance and identify hard workers or valuable output. The system's machine learning and dynamic querying features support a sensemaking loop wherein the user develops hypotheses about their crowd, tests them, and refines their selections based on ML and visual feedback. CrowdScape's contributions include:
An interface for interactive exploration of crowdworker results that supports the development of insights on worker performance by combining information on worker behavior and outputs;
Novel visualizations for crowdworker behavior;
Novel techniques for exploring crowdworker products;
Tools for grouping and classifying workers; and
Mixed initiative machine learning that bootstraps user intuitions about a crowd.

### BRIEF DESCRIPTION OF THE DRAWINGS

FIG. 1 illustrates the CrowdScape interface. (A) is a scatter plot of aggregate behavioral features. Brush on the plot to filter behavioral traces. (B) shows the distribution of each aggregate feature. Brush on the distribution to filter traces based a range of values. (C) shows behavioral traces for each worker/output pair. Mouseover to explore a particular worker's products. (D) encodes the range of worker outputs. Brush on each axis to select a subset of entries. Next to (B) is a control panel where users can switch between parallel coordinates and a textual view of worker outputs (left buttons), put workers into groups (colored right buttons), or find points similar to their colored groups (two middle button sets).

FIG. 2 presents traces of workers actions (i.e., clicking radio buttons and scrolling) while referring to a source passage at the top of their view.

FIG. 3 shows two views of submission parallel coordinates for a text comprehension quiz. (A) shows all points while (B) uses brushing to show a subset.

FIG. 4 presents brushing ranges of aggregate features.

FIG. 5 shows the text view of submissions for a survey. This view is useful if the parallel coordinates (FIG. 3) are saturated with singletons or large text entries.

FIGS. 6 and 7 show the parallel coordinates for 21 translations of 3 sentences. Note that only one translator (green) is successful. Red and orange translators copies from machine translation services. Observe the green translator's markedly different behavioral trace.

FIG. 8 shows traces for two color survey workers.

FIG. 9 shows a scatter plot for workers who summarized and tagged (red) and only tagged (blue).

FIG. 10 shows traces for workers who only tagged videos (A) and for workers who tagged and summarized videos (B).

### DETAILED DESCRIPTION

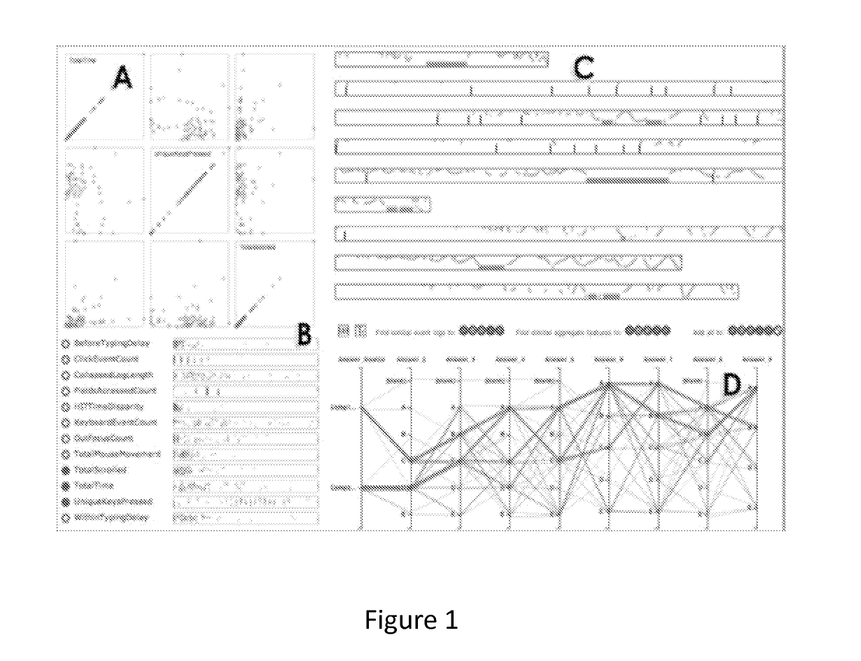

The present invention, having a user interface as illustrated in FIG. 1, is built on an online crowdsourcing market, for example, Mechanical Turk (Mturk), capturing data from both the MTurk API to obtain the output of work done on the market and a task fingerprinting system to capture worker behavioral traces, which are recorded to a data store, preferably a database. In a preferred embodiment, the present invention uses these two data sources to generate an interactive data visualization which is powered by Javascript, JQuery, and D3.js.

As an example of the use of the present invention, a requester has two hundred workers write short synopses of a collection of YouTube physics tutorials so that the best ones can be picked for use as video descriptions. The system of the present invention can be used to parse through the pool of submissions. To collect the worker behavioral traces, code was added to the crowdsourcing market interface to log worker behavior using user interface event metrics (i.e., “task fingerprinting”). The system has also stored the collection of worker outputs. Both sources of data are loaded into the system of the present invention to allow the request to visually explore the data.

First the requester wants to be sure that people actually watched the video before summarizing, so the ‘Total Time’ aggregate worker feature (a behavioral trace of actual time spent working) is used. (aggregate worker features will be discussed further below) The requester then brushes the scatter plot, selecting workers who spent a minimum reasonable amount of time on the task. The interface dynamically updates all other views, filtering out several non sequiturs and one-word summaries in the worker output panel. The requester now looks through a few worker's logs and output by hovering over their behavioral trace timelines for more details. Several are discovered that submitted good descriptions of the videos, so they are placed into the same colored group. The mixed-initiative machine learning feature is used to get suggestions for submissions similar to the labeled group of ‘good’ submissions. The list reorders, and the list is updated with several similarly good-sounding summaries. After repeating the process several times, a good list of candidates is produced, and the submissions are exported and added to YouTube.

In a preferred embodiment, the present invention utilizes two data sources: worker behavior (task fingerprints) and output. The worker behavior data is collected by instrumenting the web page in which the user completes the assigned task. As the worker works on the task, various metrics, in the form of user interface events, are logged into a data store. Examples of user interface events include, but are not limited to, mouse movements, mouse clicks, focus changes, scrolling, typing (keypresses) and delays. The output is simply what the worker produces as a result of working on the assigned task. Both the worker behavior and the output have important design considerations for interaction and visualization. In the case of worker behavior, there are two levels of data aggregation: raw event logs and aggregate worker features. Raw events are of the types mentioned above, while aggregate worker features are quantitative measurements over the whole of the task. Examples of aggregate worker features include, but are not limited to, the total time spent on the task, the total number of keypresses and the number of unique letters used.

In one aspect of the invention, raw event logs measure worker behavior on a highly granular, user interface interaction level, providing time-series data for various user interface event metrics, such as mouse movements, mouse clicks, scrolling, keypresses, delays and focus changes. A key challenge is representing this time series data in a way that is accurate yet easy to interpret and detect differences and patterns in worker behavior. To address this challenge, in one embodiment, a method has been developed to generate an abstract visual timeline of a trace. The novel method of visualizing behavioral traces focuses on promoting rapid and accurate visual understandings of worker behavior.

As an example, the time a worker takes to do certain tasks is represented horizontally, and indicators are placed based on the different activities a worker logs. Through iteration, it is determined that representing keypresses, visual scrolling, focus shifts, and clicking provided a meaningful level of information. It has been found that representing mouse movement greatly increases visual clutter and in practice does not provide useful information for the user.

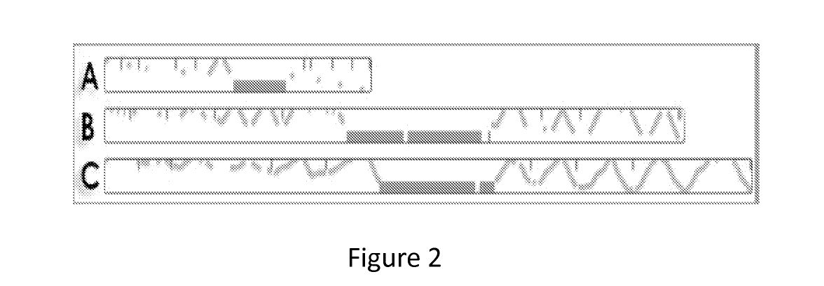

In the present embodiment of the invention, keypress events are logged as vertical red lines that form blocks during extended typing and help to differentiate behaviors such as copy-pasting versus typing. Clicks are blue flags that rise above other events so they are easily noticed. Browser focus changes are shown with black bars to suggest the ‘break’ in user concentration. Scrolling is indicated with orange lines that move up and down to indicate page position and possible shifts in user cognitive focus. To make it easy to compare workers' completion times, an absolute scale for the length of the timeline is used; this proves more useful than normalizing all timelines to the same length as it also allows accurate comparison of intervals within timelines. The colors and flow of the timelines promote quick, holistic understanding of a user's behavior. Compare the three timelines in FIG. 2. A is a lazy worker who picks radio buttons in rapid succession. B is an eager worker who refers to the source text by scrolling up to it in between clicking on radio buttons and typing answers. B's scrolling is manifested in the U-shaped orange lines as B scrolled from the button area to the source text. B's keyboard entries are also visualized. Such patterns manifest in other diligent workers within the same task (such as C).

To support larger scale exploration over hundreds or thousands of worker submissions the present invention provides a means to algorithmically cluster traces. The user first provides a cluster of exemplar points, such as the group of similarly behaving users in the earlier example (workers B and C). In one example, the average Levenshtein distance is computed from the exemplar cluster to each of the other workers' behavioral traces and orders them based on their ‘closeness’. This allows users to quickly specify an archetypical behavior or set of behaviors and locate more submissions that exhibit this archetype.

In one embodiment, aggregate features of worker behavioral traces are visualized. These have been shown to be effective in classifying the workers into low and high performing groups, or identifying cheaters. Making these numerous multi-dimensional features understandable is a key challenge. First, the number of dimensions is reduced by eliminating redundant or duplicate features in favor of features known from previous research to be effective in classifying workers. This results in twelve distinct aggregate worker features. Given the list of twelve features, a combination of 1-D and 2-D matrix scatter plots is used to show the distribution of the features over the group of workers and enable dynamic exploration. For each feature, a 1-D plot is used to show its individual characteristics (FIG. 1B). Should the user find it compelling, they can add it into a 2-D matrix of plots that cross multiple features in order to expose interaction effects (FIG. 1A).

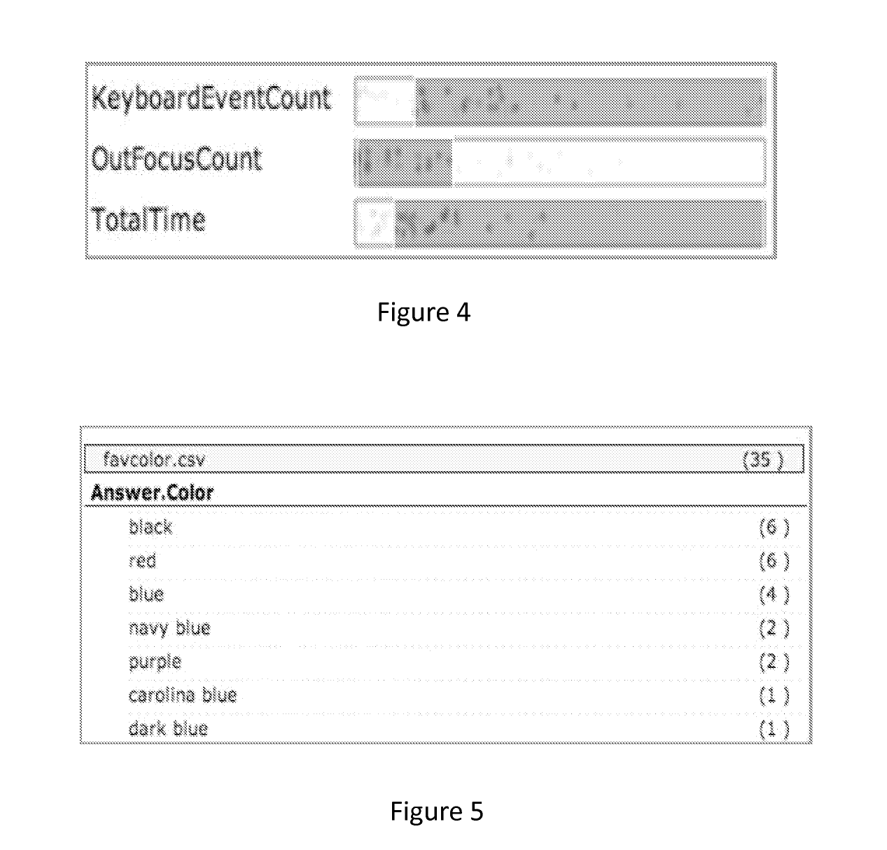

While these static visuals are effective at showing distributions and correlations, in one embodiment, dynamic querying is used to support interactive data analysis. In one example, users can brush a region in any 1D or 2D scatter plot to select points, display their behavioral traces, and desaturate or filter unselected points in all other interface elements. This interactivity reveals multidimensional relationships between features in the worker pool and allows users to explore their own mental model of the task. For example, in FIG. 4, the user has selected workers that spent a fair amount of time on task, haven't changed focus too much, and have typed more than a few characters. This example configuration would likely be useful for analyzing a task that demands concentration.

It still may be difficult to spot multi-dimensional trends and explore the features of hundreds or thousands of points. As a result, in one example, the present invention provides a means to cluster submissions based on aggregate worker features. Similar to the ML behavioral trace algorithm, the user provides exemplars, and then similar examples are found based on distance from a centroid computed from the selected examples' aggregate features. The system computes the distance for all non-example points to the centroid and sorts them by this similarity distance. This allows users to find more workers whose behavior fits their model of the task by triangulating on broad trends such as spending time before typing or scrolling.

Though visualizing worker behavior is useful, users still require an understanding of the final output a worker produced. For a scale larger than ten or twenty workers, serially inspecting their contributions can be intractable and inefficient. The present invention focuses on two different characteristics of worker submissions.

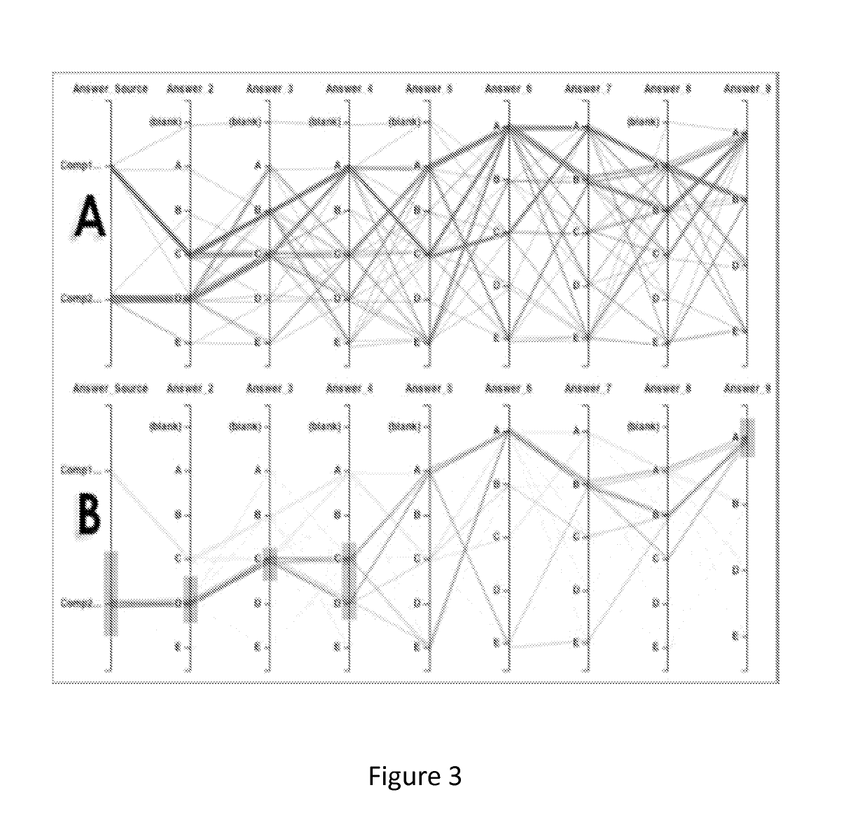

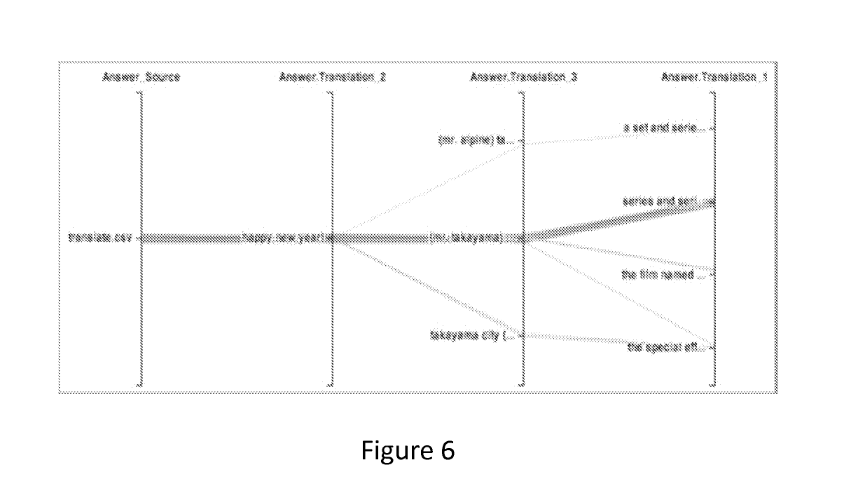

The first characteristic is that worker submissions often follow patterns. For example, if a user is extracting text from a document line-by-line, the workers that get everything right will tend to look like each other. In other words, workers that get line 1 correct are more likely to get line 2 correct and so forth. These sorts of aggregate trends over multiple answer fields are well suited for parallel coordinates visualizations. For each answer section, the system finds all possible outcomes and marks them on parallel vertical axes. Each submission then is graphed as a line crossing the axes at its corresponding answers. FIG. 6 shows one such trend, highlighting many workers who answer a certain way and only a few workers who deviate. FIG. 3 shows a far more complex relationship. To help disambiguate such complex output situations, the system allows for dynamic brushing over each answer axis. This allows a user to sift through submissions, isolating patterns of worker output (FIG. 3B).

Not all tasks generate worker output that is easy to aggregate. For writing a review of a movie, few if any workers will write the exact same text (and those that did would likely be suspect). The system provides a means to explore the raw text in a text view pane, which users can view interchangeably with the parallel coordinates pane. The text view pane shows answers sorted by the number of repeat submissions of the same text. For example, if one were to ask workers to state their favorite color, one would expect to find lots of responses to standard rainbow colors, and singleton responses to more nuanced colors such as “fuchsia” and “navy blue” (FIG. 5). The text pane view is also linked with the other views; brushing and adding items to categories is reflected through filtering and color-coded subsets of text outputs, respectively.

While on their own behavioral traces and worker output visualizations can provide useful insights to crowd organizers, together they can provide far more nuanced information. For instance, imagine the case where users are translating a passage sentence-by-sentence. Worker agreement in this case may identify a cluster of identical good translations, but also a cluster of identical poor translations copy-pasted into translation software. Behavioral trace visualization can provide additional insights: the software group may show evidence of taking very little time on the task, or using copy-paste rather than typing. They may change focus in their behavioral traces. The typing group may show large typing blocks in their traces, delays of deliberation, and take longer to complete the task. Thus, combining behavioral traces and worker outputs can provide more insight than either alone.

The present invention provides dynamic querying and triangulation, which helps users to develop mental models of behavior and output like those described above. In one example, dynamic queries update the interface in realtime as filters are applied and data is inspected. Such interaction techniques augment user understanding through instantaneous feedback and enabling experimentation. Thus, by brush-selecting on the aggregate feature of time spent in CrowdScape, the parallel coordinate display of worker output as well as behavioral traces update accordingly. Picking one point highlights it in every axis at once. Even further, the interface supports assigning group identities to points using color. This allows users to color-code groups of points based on their own model of the task and then see how the colors cluster along various features. This unity between behavior and output fosters insights into the actual process workers use to complete a task. Users develop a mental model of the task itself, understanding how certain worker behaviors correlate with certain end products. In turn, they can use this insight to formulate more effective tasks or deal with their pool of worker submission data.

The present invention reveals patterns in workers that help to unveil important answers that majority-based quality control may miss. The power of the present invention is demonstrated in the example below, which identifies outliers among the crowd. By examining the pattern of worker submissions, one can quickly hone in on unique behaviors or outputs that may be more valuable than common behaviors or submissions made by the crowd.

In this example, a task is posted that asks workers to translate text from Japanese into English, assuming that lazy workers would be likely to use machine translation to more quickly complete the task. Three phrases are used: a conventional “Happy New Year” phrase, which functions as a gold standard test to see if people are translating at all, a sentence about Gojira that does not parse well in mechanical translators, and a sentence about a village that requires domain knowledge of geography to translate properly. In this example, 21 workers completed the task at a pay rate of 42 cents. After importing the results of the task into CrowdScape, one feature in the output of the workers is immediately revealed by the parallel coordinates interface of worker products in FIG. 6. All workers passed the gold, translating ‘Happy New Year” properly. However, 16 out of 21 workers submitted the same three sentences; this pattern is clearly delineated by the dark line of multiple submissions (red in the figure). Examining their submissions shows that they likely used Google Translate, which is able to translate the first two sentences properly, but stumbles on the Gojira film sentence. Another bold line at the bottom shows a grouping of workers who used a different machine translation service (orange).

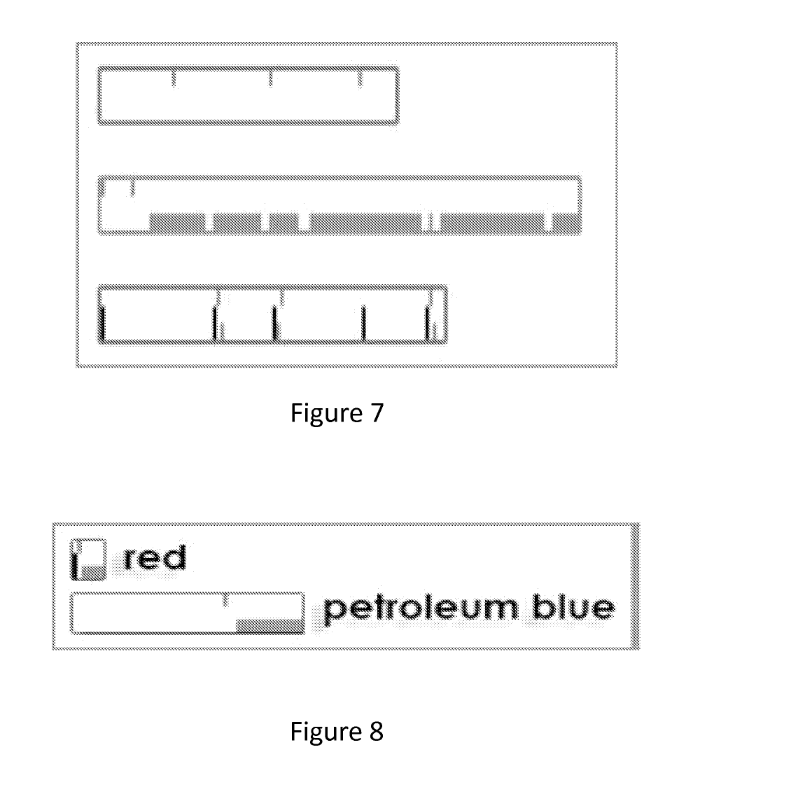

Eliminating those two groups, two workers are left. The orange line at the top shows one such worker. Note that the grammatical errors in their third submission are rather similar to the red machine translation group, suggesting more machine translation. The alignment of the parallel coordinates helps to expose these patterns. That leaves only one worker who likely translated the task manually, producing a reasonably accurate translation of the final sentence. This is confirmed by their behavioral traces (the green bar in FIG. 7), which shows evidence of time spent thinking, lack of focus changes (e.g., to copy-paste to and from translation software), and significant time spent typing (as opposed to copy-pasting).

The present invention can also support or refute intuitions about worker cognitive processes as they complete tasks. In one example, a task is posted that asks workers to use an HSV color picker tool to pick their favorite color and then tell us its name. Thirty-five workers completed the job for 3 cents each. With this task in mind, in one example, a model is developed whereby workers who spent a long time picking a color were likely trying to find a more specific shade than ‘red’ or ‘blue’ which are easy to obtain using the color picker. In turn, workers that identified a very specific shade are more likely to choose a descriptive color name since they went to the trouble. As anticipated, the three most common colors were black, red, and blue (FIG. 5). To explore worker cognition further, in one example, submissions are filtered by the amount of time workers waited before typing in their color. This reduces the amount of submissions, revealing workers who write colors such as “Carolina blue”, “hot pink”, or “teal”. The difference is evident in the workers' behavioral traces as well (FIG. 8). This example demonstrates that the present invention supports the investigation of theories about worker cognitive processes and how they relate to workers' end products.

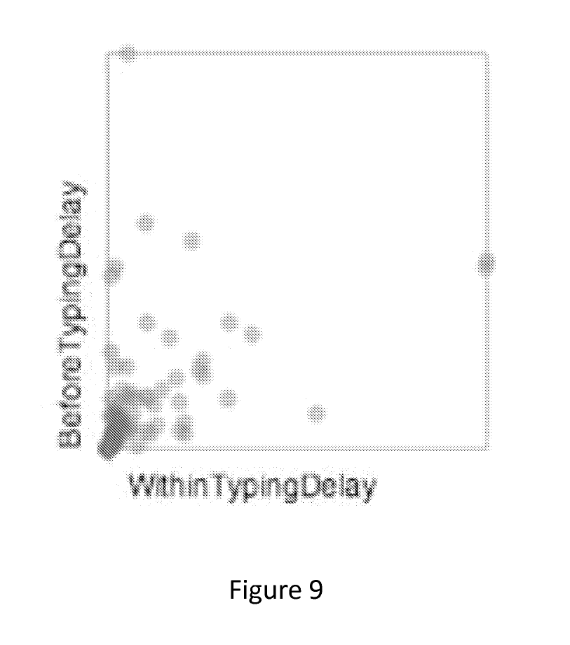

The present invention supports feedback loops that are especially helpful when worker output is extremely sparse or variable. In one example, fifty workers are asked to describe their favorite place in 3-6 sentences for 14 cents each. No two workers provide the same response, making traditional gold standard and worker majority analysis techniques inapplicable. Instead, we explored the hypothesis that good workers would deliberate about their place and description and then write about it fluidly. This would manifest through a higher time before typing and little time spent between typing characters. After configuring the scatterplot matrix to pair the two aggregate features for typing delays (similar to FIG. 9), a region is selected on the graph that describes our hypothesis, resulting in 10 selected points. By hovering over each one, the responses are scanned, binning good ones into a group. Next, the machine learning similarity feature is used to find points that have similar aggregate worker features. This is chosen over finding similar traces because workers in practice do not scroll, click, or change focus much. After points with similar features are found, the same process is repeated, quickly binning good descriptions. After one more repetition, a sample of 10 acceptable descriptions is yielded. The ending response set satisfied the goal of finding a diverse set of well-written favorite places. Descriptions ranged from the beaches of Goa, India, a church in Serbia, a park in New York, and mountains in Switzerland. By progressively winnowing the submissions by building a feedback loop using recommendations and binning, the present invention allows for the quick development of a successful final output set.

To explore this feedback loop in more detail, 96 workers are used to tag science tutorial videos from YouTube for either 25 or 32 cents. Some workers also summarized the video, based on a design pattern for having easily monitored tasks that engage workers in task-relevant processing. Binning the workers into two groups immediately shows that workers who only gave tags (in blue) spent less time than summarizers (in red) deliberating before and during their text entry (FIG. 9).

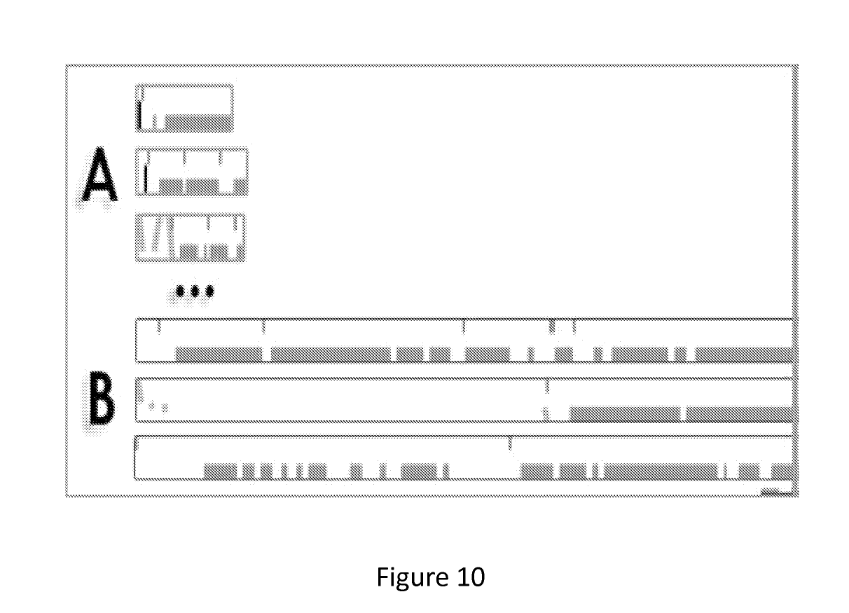

The behavioral traces also expose another nuance in the pool of workers: some workers watch the whole video then type, other workers type while watching, and some seemingly don't watch at all. First, the entire pool of traces is examined, looking for telltale signs of people who skipped the video such as no focus changes (interactions with the flash video player) and little white space (pauses). After identifying several of these traces, the machine learning system is used to generate similarity ratings for the rest of the traces based on the traces of our group of exemplars. This yielded several more similar cases where workers did not watch the video and instead added non-sequitur tags such as “extra”, “super” and “awesome”. Among these cases were some good submissions, suggesting that our initial insight that shorter traces might correlate to worse tags is incomplete. However, when examining strings highly dissimilar to the bad examples, they were almost universally good. This was extreme enough that the bottom half of the list of submissions could be sorted by similarity to the bad examples and still have a sufficient set of good tags. FIG. 10 illustrates the contrast between the bad exemplars and the set of good ‘dissimilar’ points.

The CrowdScape invention has been presented herein. The invention is not meant to be limited by examples of implementation or use provided, nor is the invention meant to be limited to use or implementation with the Mechanical Turk web site. The scope of the invention is captured in the claims which follow.

We claim:

1. A system for evaluating crowd work comprising:
a computer;
a data store, stored on said computer, said data store containing discrete user interface events of different types recorded as individual workers in said crowd performed an assigned task; and
software, running on said computer, said software providing the functions of:
obtaining output generated by each of said workers and displaying said output;
providing visual timelines for one or more workers, said timelines showing the timing of one of more of said types of user interface events stored in said data store, said types of events being represented along said timeline using a different symbol for each type of displayed event;
allowing the creation of a cluster of individual workers based on a user selection of the quality of said output or the characteristics of said visual timelines; and
evaluating all workers using a machine learning algorithm and presenting a listing of those workers having characteristics similar to said selected individual workers.

2. The system of claim 1 wherein said clusters are created by placing individual workers into color-coded groups.

3. The system of claim 1 wherein said software further provides the functions of:
creating aggregate worker features for each of said workers, said aggregate worker features consisting of quantitative summaries of one or more user interface events for each individual worker;
displaying one or more of said aggregate worker features using matrix scatter diagrams; and
allowing the creation of a cluster of individual workers based on a user selection of desired aggregate worker features;
evaluating non-selected workers for a distance from a centroid computed from the aggregate worker features of said cluster; and
ordering all evaluated workers based on said distance.

4. The system of claim 3 wherein a single aggregate worker feature is displayed in a 1-D scatter plot and further wherein multiple aggregate worker features may be displayed in a single 2-D scatter plot.

5. The system of claim 3 wherein said software further provides the function of displaying a visual representation of the distribution of each of said aggregate worker features.

6. The system of claim 3 wherein said aggregate worker features may be filtered by manipulation of said scatter diagrams by a user.

7. The system of claim 1 wherein said function of displaying output allows said output to be displayed in a textual or graphical form or in parallel coordinate form.

8. The system of claim 7 wherein said displayed outputs may be filtered by direct manipulation of said parallel coordinate form.

9. The system of claim 1 wherein said software further provides the functions of:
allowing a user to specify a desired archetypical behavior or set of behaviors by selecting a cluster of example workers having similar behavior;
evaluating non-selected workers based on the distance between each worker's behavior and the behavior of said cluster of example workers; and
ordering all evaluated workers based on said distance.

10. The system of claim 9 wherein said distance is evaluated using a Levenshtein algorithm.

11. The system of claim 1 wherein said discrete user interface events includes mouse movements, mouse clicks, scrolling, keypresses and delays.

12. The system of claim 1 wherein said visual timelines for one or more workers are scaled to an absolute time scale, such as to allow a visual comparison of the total time spent on said task by each of said workers.

13. The system of claim 1 wherein said data store is a database.
